(19) United States
(12) Patent Application Publication
(10) Pub. No.: US 2026/0299877 A1
(43) Pub. Date: Oct. 1, 2026

(54) CONTROL METHOD AND ELECTRONIC DEVICE

(71) Applicant: Lenovo (Beijing) Limited, Beijing (CN)

(72) Inventor: Yunfeng PAN, Beijing (CN)

(21) Appl. No.: 19/549,272

(22) Filed: Feb. 25, 2026

(30) Foreign Application Priority Data
Mar. 31, 2025 (CN) 202510392584.X

(51) Int. Cl. G06F 3/16

(52) U.S. Cl. CPC G06F 3/165

(57) ABSTRACT

A control method includes obtaining first sensing information configured to indicate a device state of an electronic device, and in response to the first sensing information indicates that the device state of the electronic device is a first device state, configuring an audio output apparatus to a first output mode, to enable the audio output apparatus to output audio in the first output mode in response to a call instruction. When the electronic device is in the first device state, a target object of the electronic device blocks an audio output area of the audio output apparatus.

### CROSS-REFERENCE TO RELATED APPLICATION

This application claims priority to Chinese Patent Application No. 202510392584.X, filed on Mar. 31, 2025, the entire content of which is incorporated herein by reference.

### TECHNICAL FIELD

The present disclosure generally relates to the field of device control technology and, more particularly, to a control method and an electronic device.

### BACKGROUND

Foldable screen phones may undergo changes in form during use due to user needs, and these changes in form may cause the audio output opening on the foldable phone to be blocked, resulting in a poor listening experience for the user.

### SUMMARY

In accordance with the disclosure, there is provided a control method including obtaining first sensing information configured to indicate a device state of an electronic device, and in response to the first sensing information indicates that the device state of the electronic device is a first device state, configuring an audio output apparatus to a first output mode, to enable the audio output apparatus to output audio in the first output mode in response to a call instruction. When the electronic device is in the first device state, a target object of the electronic device blocks an audio output area of the audio output apparatus.

Also in accordance with the disclosure, there is provided an electronic device including a sensing component configured to obtain first sensing information configured to indicate a device state of the electronic device, an audio output apparatus configured to output audio and having a first output mode and a second output mode different from the first output mode, and a processor configured to, in response to the first sensing information indicating that the device state of the electronic device is a first device state, configure the audio output apparatus to the first output mode, to enable the audio output apparatus to output audio in the first output mode in response to a call instruction. When the electronic device is in the first device state, a target object of the electronic device blocks an audio output area of the audio output apparatus.

Also in accordance with the disclosure, there is provided a non-transitory computer-readable storage medium storing instructions that, when executed by a processor, cause an electronic device including the processor to obtain first sensing information configured to indicate a device state of the electronic device, and in response to the first sensing information indicating that the device state of the electronic device is a first device state, configure an audio output apparatus to a first output mode, to enable the audio output apparatus to output audio in the first output mode in response to a call instruction. When the electronic device is in the first device state, a target object of the electronic device blocks an audio output area of the audio output apparatus.

### BRIEF DESCRIPTION OF THE DRAWINGS

In order to more clearly illustrate the technical solutions of the embodiments of the present disclosure, the drawings for the description of the embodiments will be briefly introduced below. Obviously, the drawings described below are only some embodiments of the present disclosure, and those skilled in the art can obtain other drawings based on these drawings without creative effort.

FIG. 1 is a flowchart of a control method consistent with the present disclosure.

FIG. 2 schematically shows the earpiece audio output area being blocked on a foldable phone.

FIG. 3 schematically shows the audio output area at the top front of a flexible screen TV being blocked.

FIG. 4 schematically shows the earpiece audio output area being blocked, while the speaker audio output area is not blocked on a foldable phone.

FIG. 5 schematically shows the audio output area at the top front of a flexible screen TV being blocked, while the audio output areas on both sides are not blocked.

FIG. 6 is another flowchart of a control method consistent with the present disclosure.

FIG. 7 schematically shows that the user perceives the same volume in both the unfolded and folded states when a foldable phone is held next to the ear in the embodiments of the present disclosure.

FIG. 8 schematically shows that the user perceives the same volume in both the unfolded and folded states when a foldable phone is moved away from the ear in the embodiments of the present disclosure.

FIG. 9 is a schematic structural diagram of a control apparatus consistent with the present disclosure.

FIG. 10 is another schematic structural diagram of a control apparatus consistent with the present disclosure.

FIG. 11 is another schematic structural diagram of a control apparatus consistent with the present disclosure.

FIG. 12 is a schematic structural diagram of an electronic device consistent with the present disclosure.

FIG. 13 is a partial schematic structural diagram of an electronic device consistent with the present disclosure.

FIG. 14 is another partial schematic structural diagram of an electronic device consistent with the present disclosure.

FIG. 15 is another schematic structural diagram of an electronic device consistent with the present disclosure.

FIG. 16 is another schematic structural diagram of an electronic device consistent with the present disclosure.

### DETAILED DESCRIPTION OF THE EMBODIMENTS

The technical solutions in the embodiments of the present disclosure will be described below with reference to the accompanying drawings. Obviously, the described embodiments are only some embodiments of the present disclosure, not all embodiments. Based on the described embodiments, all other embodiments obtained by those skilled in the art without creative effort are within the scope of the present disclosure.

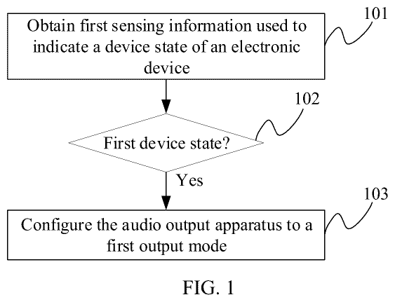

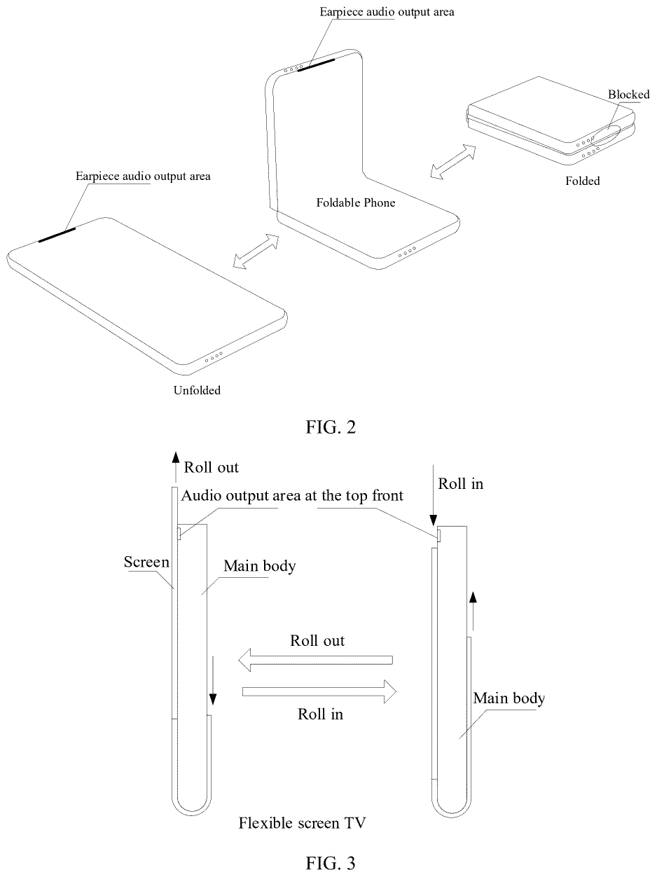

FIG. 1 is a flowchart of a control method consistent with the present disclosure. This method is applicable to electronic devices with audio output apparatus whose audio output area can be blocked by their own components, such as the foldable phone shown in FIG. 2, or the flexible screen TV or rollable screen TV shown in FIG. 3. The technical solution in the embodiments of the present disclosure is used to improve the user's listening experience with the electronic device.

Specifically, the method in the embodiments of the present disclosure includes the following.

At 101, first sensing information used to indicate a device state of an electronic device is obtained.

In some embodiments, the first sensing information can be collected through a Hall sensor or other means. The first sensing information can indicate the device state of the electronic device. The device state of the electronic device refers to whether a target object of the electronic device blocks the audio output area of the audio output apparatus.

For example, taking a foldable phone as an example, in the embodiments of the present disclosure, a Hall sensor in the foldable phone is used to collect the first sensing information, which indicates whether the earpiece audio output area of the foldable phone is blocked by the lower part of the phone. In some embodiments, the first sensing information indicates whether the upper and lower parts of the foldable phone are folded or unfolded. In the device state where the upper and lower parts of the phone are unfolded, the earpiece audio output area is not blocked; in the device state where the upper and lower parts of the phone are folded, the earpiece audio output area is blocked by the lower part of the phone, as shown in FIG. 2.

As another example, taking a flexible screen TV as an example, in the embodiments of the present disclosure, a Hall sensor in the flexible screen TV is used to collect the first sensing information, which indicates whether the screen of the flexible screen TV is rolled out, causing the audio output area at the top front of the TV body to be blocked. In some embodiments, the first sensing information indicates whether the screen of the flexible screen TV is rolled out or rolled in. In the device state where the flexible screen is rolled into the TV body, the audio output area at the top front is not blocked; in the device state where the flexible screen is rolled out from the TV body, the audio output area at the top front is blocked by the rolled-out flexible screen, as shown in FIG. 3.

At 102, whether the first sensing information indicates that the device state of the electronic device is the first device state is determined. If the first sensing information indicates that the device state of the electronic device is the first device state, 103 is executed.

In this case, the electronic device is in the first device state when the target object of the electronic device blocks the audio output area of the audio output apparatus. The audio output area of the audio output apparatus is the audio output area in a second output mode. When the electronic device is in the first device state, the audio output area of the audio output apparatus in the second output mode is blocked by the target object in the electronic device. However, the audio output area of the audio output apparatus in the first output mode is not blocked by any object in the electronic device.

Correspondingly, the electronic device is in the second device state when the target object of the electronic device does not block the audio output area of the audio output apparatus. Specifically, when the electronic device is in the second device state, the audio output area of the audio output apparatus in the second output mode is not blocked by the target object in the electronic device.

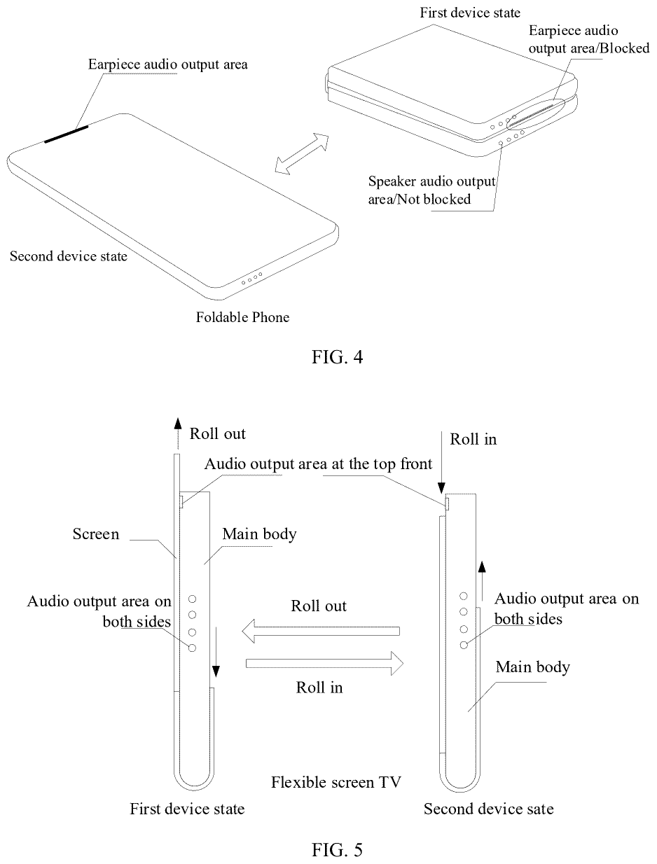

For example, taking a foldable phone as an example, the audio output area in the earpiece mode is located at the top edge of the upper part of the phone adjacent to the screen, and the audio output area in the speaker mode is located at the upper and lower sides of the phone, as shown in FIG. 4. In the first device state, i.e., the folded state of the phone, the audio output area in the earpiece mode is blocked by the folded lower part. In the second device state, i.e., the unfolded state of the phone, the audio output area in the earpiece mode is not blocked, and the audio output areas on the upper and lower sides in the speaker mode are not blocked.

For example, taking a flexible screen TV as an example, the audio output area in the music playback mode (with only one audio output opening) is located at the top front of the TV body, and the output area in the video playback mode (with two audio output openings) is located at both sides of the TV main body, as shown in FIG. 5. In the first device state, where the flexible screen of the TV is rolled out, the audio output area at the front top is blocked by the rolled-out flexible screen. In the second device state, where the flexible screen of the TV is rolled in, the audio output area at the front top is not blocked, and the audio output areas on both sides of the main body are not blocked in video playback mode.

At 103, the audio output apparatus is configured to a first output mode.

The first output mode is a mode in which audio is output through the unblocked audio output areas of the electronic device in the first device state. For example, in the speaker mode of a foldable phone, audio is output through the audio output openings on the upper and lower sides of the foldable phone. As another example, in the video playback mode of a flexible screen TV, audio is output through the audio output openings on both sides of the main body of the flexible screen TV.

It should be noted that after the audio output apparatus is configured to the first output mode, the audio output apparatus outputs audio in the first output mode in response to a call instruction. The call instruction is used to call the audio output apparatus to output the audio corresponding to the call instruction.

For example, when a foldable phone is in the folded state, if there is an incoming call, the speaker in the foldable phone is activated, and the speaker outputs the incoming call ringtone through the audio output openings in the speaker mode, preventing poor ringtone playback due to the audio output opening in the earpiece mode being blocked by the lower half of the phone.

As another example, when a flexible screen TV is in the screen rolled-out state, if there is music, the speaker in the flexible screen TV is activated, and the speaker outputs music through the audio output openings in the video playback mode, preventing poor music listening experience due to the audio output openings in the music playback mode being blocked by the rolled-out screen.

As can be seen from the above technical solution, in the control method of the present disclosure, the device state of the electronic device is determined by obtaining the first sensing information, and the output mode of the audio output apparatus is configured accordingly. Specifically, when the electronic device is in the first device state where its audio output area is blocked by its target object, the audio output apparatus is configured to the first output mode, so that the audio output apparatus can output audio in the first output mode in response to a call instruction. In the embodiments of the present disclosure, the output mode of the audio output apparatus can be configured when the electronic device is in a device state where the audio output area is blocked. This prevents the audio output from being blocked due to the blocked audio output area, thereby improving the user's listening experience with the electronic device.

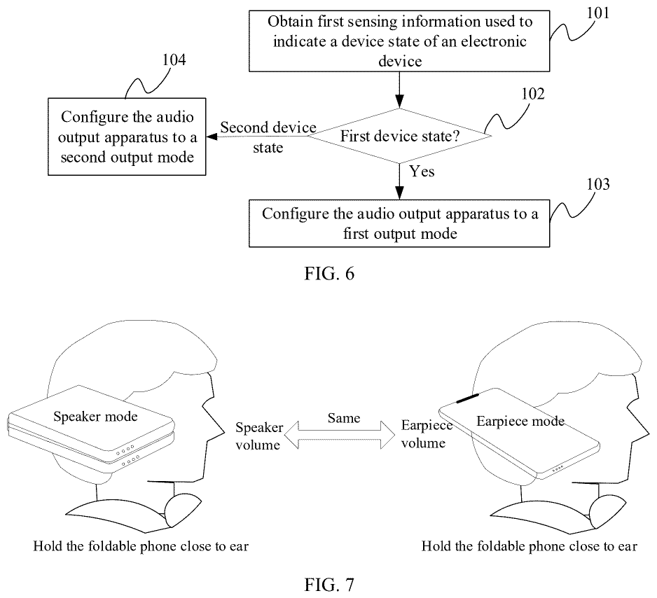

Based on the above disclosure, if it is determined at 102 that the first sensing information indicates that the device state of the electronic device is the second device state, then the following process can be performed, as shown in FIG. 6:

At 104, the audio output apparatus is configured to the second output mode.

After the audio output apparatus is configured to the second output mode, the audio output apparatus can output audio in the second output mode in response to the call instruction.

The second output mode is different from the first output mode. For example, the second output mode is the earpiece mode of a foldable phone, and the first output mode is the speaker mode of the foldable phone. As another example, the second output mode is the music playback mode of a flexible screen TV, and the first output mode is the video playback mode of the flexible screen TV.

For example, when a foldable phone is in a folded state, if there is an incoming call, the speaker in the foldable phone is activated, and the speaker outputs the incoming call ringtone through the audio output opening in the speaker mode, preventing poor ringtone playback due to the audio output opening in the earpiece mode being blocked by the lower part of the phone; while when the foldable phone is in an unfolded state, if there is an incoming call, the speaker in the foldable phone is activated, and the speaker outputs the incoming call ringtone through the audio output opening in the earpiece mode.

As another example, when a flexible screen TV is in a screen-rolled-out state, if there is music, the speaker in the flexible screen TV is activated, and the speaker outputs music through the audio output opening in the video playback mode, i.e., the audio output opening at the top front of the main body, preventing poor music listening experience due to the audio output opening in the music playback mode being blocked by the rolled-out screen; while when the flexible screen TV is in a screen-rolled-in state, if there is music, the speaker in the flexible screen TV is activated, and the speaker outputs music through the audio output opening in the music playback mode.

Based on the above examples, in the embodiments of the present disclosure, the audio output apparatus can be activated in response to the establishment of a call connection. That is, the call instruction is an instruction to establish a call connection.

In some embodiments, establishment of a call connection refers to the electronic device receiving a call request, but the electronic device does not connect the call, and the audio output apparatus outputs the call prompt audio triggered by the call request, such as a ringtone.

In some embodiments, establishment of a call connection refers to: after the electronic device receives a call request, the electronic device connects the call, and the audio output apparatus outputs the call audio in the call connection, such as the voice signal of the caller.

For example, in a folded state, if a foldable phone receives a call from another user and connects the call, the speaker in the foldable phone is activated and outputs the voice signal of the caller through the audio output opening in the speaker mode, avoiding poor ringtone playback quality caused by the audio output opening being blocked by the lower part of the phone in earpiece mode. In an unfolded state, if the foldable phone receives a call from another user and connects the call, the speaker in the foldable phone outputs the voice signal of the caller through the audio output opening in the earpiece mode.

In some embodiments, the present disclosure can also obtain second sensing information used to indicate the user's use state of the electronic device. The second sensing information is used to determine whether the user is using the electronic device in the first use state or the second use state.

The first use state is the state where the user's ear is close to the electronic device, and the second use state is the state where the user's ear is away from the electronic device. In the present disclosure, the second sensing information can be collected through a distance sensor or other means to determine the distance between the user's ear and the electronic device. Based on the comparison between the distance and a threshold, it is determined whether the user's ear is close to or away from the electronic device.

Based on this, if the second sensing information indicates the first use state, when the electronic device is in the first device state, and the audio output apparatus outputs audio in the first output mode, such that the perceived volume by the user as the user is using the electronic device in the first use state is the same as the perceived volume by the user as the user is using the electronic device in the first use state when the electronic device is in the second device state and the audio output apparatus outputs audio in the second output mode. In the present disclosure, “volume is the same” can be understood as the volume being within the same numerical range, or the difference between the volumes being less than a first threshold.

For example, as shown in FIG. 7, when the user holds the foldable phone to their ear, the speaker of the foldable phone in the folded state outputs audio through the audio output opening in the speaker mode, resulting in the volume perceived by the user, is the same as the volume perceived by the user when the speaker of the foldable phone in the unfolded state is outputting audio through the audio output opening in the earpiece mode. Thus, even if the foldable phone is folded and uses the audio output opening in the speaker mode to output audio, as long as the user holds the phone to their ear, the perceived volume remains the same as when the foldable phone is unfolded and uses the audio output opening in the earpiece mode to output audio. This prevents the user from experiencing excessively loud volume due to using the audio output opening in the speaker mode to output audio, thereby improving the user's audio listening experience.

Based on the above examples, if the second sensing information indicates the second use state, and the electronic device is in the second device state, then the audio output apparatus switches from the second output mode to the first output mode. For example, in the unfolded state of the foldable phone, if the user's ear is away from the phone, the speaker is switched to speaker mode.

Based on this, when the electronic device is in the first device state, the audio output apparatus outputs audio in the first output mode, such that the perceived volume by the user as the user is using the electronic device in the second use state is the same as the perceived volume by the user as the user is using the electronic device in the second use state when the electronic device is in the second device state and the audio output apparatus outputs audio in the first output mode.

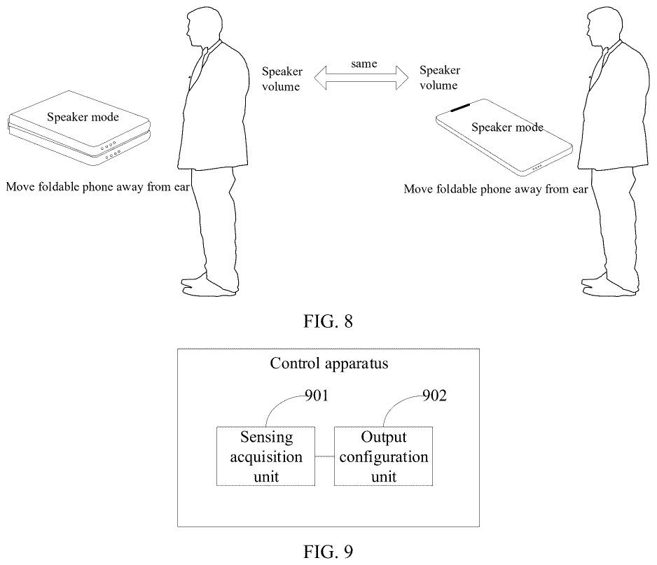

For example, as shown in FIG. 8, when the user takes the foldable phone away from their ear, the volume perceived by the user from the speaker of the foldable phone in the folded state, with the speaker outputting audio through the audio output opening in speaker mode, is the same as the volume perceived by the user from the speaker of the foldable phone in the unfolded state, with the speaker outputting audio through the audio output opening in speaker mode. Thus, even if the foldable phone is unfolded, as long as the user takes the phone away from their ear, the perceived volume remains the same as when the foldable phone is folded and uses the audio output opening in the speaker mode to output audio. This prevents the user from experiencing excessively loud volume due to using the audio output opening in the speaker mode to output audio when unfolded, and also prevents the user from experiencing excessively low volume due to using the audio output opening in the speaker mode to output audio when folded, thereby improving the user's audio listening experience.

In some embodiments, the volume parameter of the first output mode of the audio output apparatus when the electronic device is in the first device state is greater than the volume parameter of the first output mode of the audio output apparatus when the electronic device is in the second device state. This ensures that when the electronic device is in the first device state, the first output mode of the audio output apparatus uses a larger volume parameter, so that the user perceives the same volume whether the electronic device is in the first device state or second device state.

For example, for a foldable phone, the speaker volume in the folded state is greater than the speaker volume in the unfolded state. This ensures that when the user moves the unfolded phone away from their ear, and the speaker switches from earpiece mode to speaker mode, the perceived volume by the user remains the same.

In some embodiments, before the electronic device is shipped from the factory, an intelligent model can be trained using multiple user-labeled audio samples. This allows the intelligent model to learn audio output parameters that provide comfortable listening for the user, including at least one of volume, frequency response, channels, or timbre. Based on this, the intelligent model can establish a mapping relationship between device state, use state, and audio output parameters, and this mapping relationship can be written into the electronic device. After the electronic device is shipped from the factory, during user use, the matched audio output parameters can be determined from the mapping relationship based on the collected first sensing information and second sensing information, to adjust the volume, frequency response, channels, timbre, and other audio output parameters of the audio output by the audio output apparatus, thereby improving the user's listening experience when listening to audio.

In some embodiments, an intelligent model can be deployed in the electronic device. This intelligent model is trained based on the historical audio data of the user of the electronic device. This historical data can include: the first sensing information and second sensing information when the user uses the audio output apparatus to output audio, the audio output parameters of the historical audio output by the user of the electronic device using the audio output apparatus, and the operation data of the user of the electronic device setting the audio output parameters, etc.

Based on this, in the embodiments of the present disclosure, before the audio output apparatus outputs audio, an intelligent model can be used to adjust the audio output parameters of the audio output by the audio output apparatus based on the first sensing information and the second sensing information. This ensures that the audio output by the audio output apparatus meets the user's listening needs for the audio, thereby achieving a personalized audio listening effect and improving the user's listening experience.

For example, in a scenario where a foldable phone is folded and moved away from the ear, if there is an incoming call, the foldable phone can use an intelligent model to adjust the voice signal of the caller to an appropriate volume, frequency response, channel, and timbre, thereby improving the user's experience when listening to the caller's voice.

As shown in FIG. 9, which is a schematic structural diagram of a control apparatus consistent with the present disclosure, this apparatus can be deployed in an electronic device with an audio output apparatus whose audio output area can be blocked by its own components, such as the foldable phone shown in FIG. 2, or the flexible screen TV or rollable screen TV shown in FIG. 3. The technical solution in the embodiments of the present disclosure is used to improve the user's listening experience with the electronic device.

In some embodiments, the apparatus in the embodiments of the present disclosure may include the following units.

A sensing acquisition unit 901, configured to obtain first sensing information that indicates the device state of the electronic device.

An output configuration unit 902, configuring the audio output apparatus to a first output mode if the first sensing information indicates the device state of the electronic device as a first device state, so that the audio output apparatus outputs audio in the first output mode in response to a call instruction.

The electronic device is in the first device state, and the target object of the electronic device blocks the audio output area of the audio output apparatus.

Based on the above examples, in the control apparatus consistent with the present disclosure, by obtaining the first sensing information, the device state of the electronic device is determined, and the output mode of the audio output apparatus is configured accordingly. Specifically, when the electronic device is in the first device state where its audio output area is blocked by its target object, the audio output apparatus is configured to the first output mode, so that the audio output apparatus can output audio in the first output mode in response to a call instruction. Therefore, in the embodiments of the present disclosure, the output mode of the audio output apparatus can be configured when the electronic device is in a device state where the audio output area is blocked, thus preventing the audio output from being hindered due to the audio output area being blocked, improving the user's listening experience with electronic devices.

In some embodiments, the output configuration unit 902 is also used to: if the first sensing information indicates that the device state of the electronic device is a second device state, configure the audio output apparatus to a second output mode, so that the audio output apparatus outputs audio in the second output mode in response to a call instruction. The second output mode is different from the first output mode.

The electronic device is in the second device state, and the target object of the electronic device does not block the audio output area of the audio output apparatus.

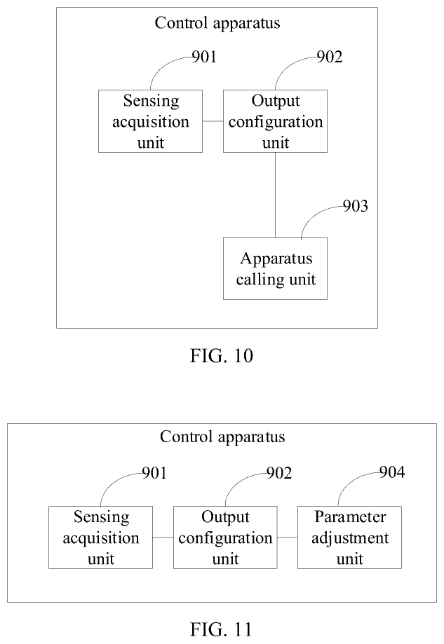

In some embodiments, the apparatus in the embodiments of the present disclosure also includes the following units, as shown in FIG. 10.

Apparatus calling unit 903, configured to call the audio output apparatus in response to the establishment of a call connection.

In some embodiments, the sensing acquisition unit 901 is also configured to: obtain second sensing information used to indicate the user's use state of the electronic device.

When the electronic device is in the first device state, the volume perceived by the user as the user is using the electronic device in the first use state when the audio output apparatus outputs audio in the first output mode is the same as the volume perceived by the user as the user is using the electronic device in the first use state when the electronic device is in the second device state and the audio output apparatus outputs audio in the second output mode.

In some embodiments, if the second sensing information indicates a second use state, and the electronic device is in the second device state, the audio output apparatus switches from the second output mode to the first output mode. The volume perceived by the user when the electronic device is in the first device state and the audio output apparatus outputs audio in the first output mode as the user is using the electronic device in the second use state is the same as the volume perceived by the user when the electronic device is in the second device state and the audio output apparatus outputs audio in the first output mode as the user is using the electronic device in the second use state. The volume parameter of the first output mode of the audio output apparatus when the electronic device is in the first device state is greater than the volume parameter of the first output mode of the audio output apparatus when the electronic device is in the second device state.

In some embodiments, the apparatus in the embodiments of the present disclosure also includes the following units, as shown in FIG. 11.

A parameter adjustment unit 904, configured to adjust the audio output parameters of the audio output apparatus before the audio output apparatus outputs audio, using an intelligent model based on the first sensing information and the second sensing information. The audio output parameters include at least one of volume, frequency response, or timbre. The intelligent model is trained based on historical data of audio data used by the user of the electronic device.

It should be noted that reference can be made to the corresponding content in the foregoing description for specific implementation methods of each unit in the embodiments of the present disclosure.

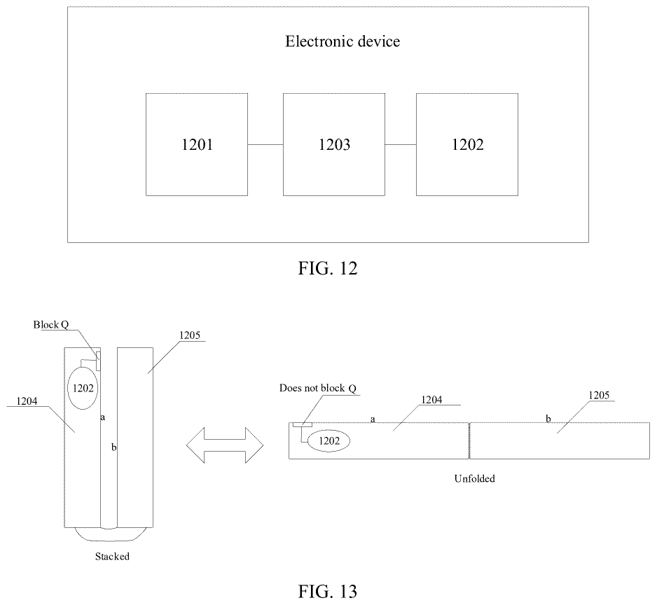

FIG. 12 a schematic structural diagram of an electronic device provided in the embodiment of the present disclosure. The electronic device in the present disclosure can be an electronic device with an audio output apparatus whose audio output area can be blocked by its own components, such as the foldable phone shown in FIG. 2, or the flexible screen TV or rollable screen TV shown in FIG. 3. The technical solution in the embodiments of the present disclosure is used to improve the user's listening experience of the electronic device.

Specifically, the electronic device in the embodiments of the present disclosure may include the following.

A first sensing component 1201, configured to obtain a first sensing parameter (first sensing information). The first sensing parameter is used to characterize the device state of the electronic device.

An audio output apparatus 1202, configured to output audio. The audio output apparatus 1202 includes a first output mode and a second output mode different from the first output mode.

A processor 1203, used to configure the audio output apparatus 1202 to the first output mode if the first sensing information indicates that the device state of the electronic device is a first device state, so that the audio output apparatus 1202 outputs audio in the first output mode when responding to a call instruction.

When the electronic device is in the first device state, the target object of the electronic device blocks the audio output area of the audio output apparatus 1202.

Based on the above technical solution, in an electronic device consistent with the present disclosure, by obtaining the first sensing information, the device state of the electronic device is determined, and the output mode of the audio output apparatus is configured accordingly. Specifically, when the electronic device is in the first device state where its target object blocks the audio output area, the audio output apparatus is configured to the first output mode, so that the audio output apparatus can output audio in the first output mode when responding to a call instruction. That is, in the embodiments of the present disclosure, the output mode of the audio output apparatus can be configured when the electronic device is in a state where the audio output area is blocked. This prevents the audio output from being hindered due to the audio output area being blocked, thereby improving the user's listening experience with the electronic device.

In some embodiments, the electronic device also includes a first body 1204 and a second body 1205, such as a foldable phone including two bodies that can be stacked and unfolded. The audio output apparatus 1202 is located within the first body 1204, and the audio output area Q of the audio output apparatus 1202 is located at the first surface a of the first body 1204, as shown in FIG. 13.

When the first body 1204 and the second body 1205 are stacked, the electronic device is in a first device state, and the first surface b of the second body 1205 blocks the audio output area. In this case, the audio output apparatus 1202 is configured to the first output mode. When the first body 1204 and the second body 1205 are unfolded, the electronic device is in a second device state, the first surface a of the first body 1204 and the first surface b of the second body 1205 are coplanar, and the second body 1205 does not block the audio output area Q of the audio output apparatus 1202. In this case, the audio output apparatus 1202 is configured to the second output mode.

Coplanar means the first surface a and the first surface b form the same plane.

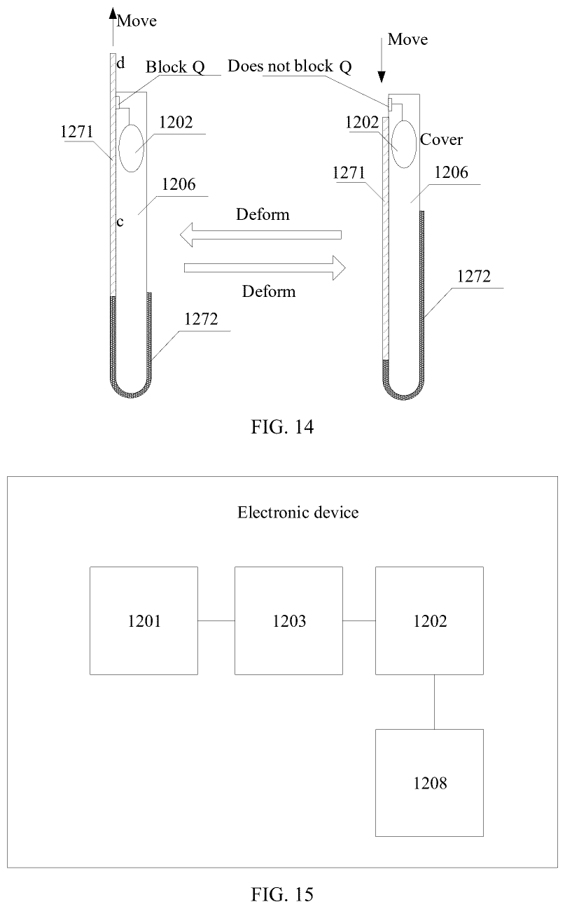

In some embodiments, the electronic device also includes a body 1206 and a flexible screen 1207. The audio output apparatus 1202 is located within the body 1206, and the audio output area Q of the audio output apparatus 1202 is located at the first surface c of the body 1206, as shown in FIG. 14. The flexible screen 1207 includes a first part 1271 and a second part 1272, where the second part 1272 is a deformable part, and the first part 1271 moves relative to the body 1206 based on the deformation of the second part 1272. The first surface d of the first part 1271 is parallel to the first surface c of the body 1206.

Consistent with the present disclosure, when the second part 1272 deforms to the first form, the electronic device is in the first device state, and the first part 1271 moves to the first position. The first surface d of the first part 1271 at the first position blocks (i.e., covers) the audio output area Q of the audio output apparatus 1202, meaning the first part 1271 blocks the audio output area of the audio output apparatus 1202. In this case, the audio output apparatus 1202 is configured to the first output mode. When the second part 1272 deforms to the second form, the electronic device is in the second device state, and the first part 1271 moves to the second position. The first surface d of the first part 1271 at the second position does not block the audio output area Q of the audio output apparatus 1202. In this case, the audio output apparatus 1202 is configured to the second output mode.

In some embodiments, the electronic device also includes: a communication component 1208, as shown in FIG. 15, which is used to establish a call connection between the electronic device and other devices. The audio output apparatus 1202 is activated in response to the call connection being established.

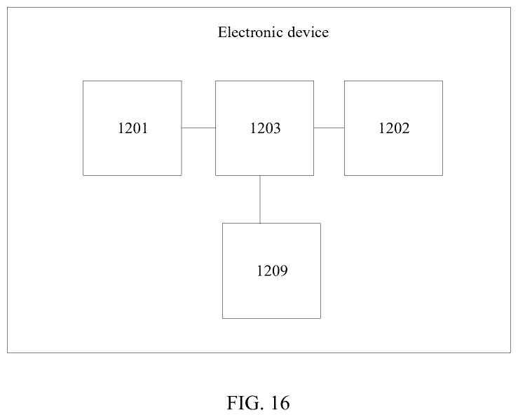

In some embodiments, the electronic device also includes: a second sensing component 1209, as shown in FIG. 16.

The second sensing component 1209 is used to obtain second sensing information that indicates the user's use state of the electronic device.

When the electronic device is in the first device state, the audio output apparatus 1202 outputs audio in the first output mode such that the volume perceived by the user as the user is using the electronic device in the first use state is the same as the volume perceived by the user as the user is using the electronic device in the first use state when the electronic device is in the second device state and the audio output apparatus 1202 outputs audio in the second output mode.

It should be noted that if the second sensing information indicates the second use state, and the electronic device is in the second device state, the audio output apparatus 1202 switches from the second output mode to the first output mode.

When the electronic device is in the first device state, the audio output apparatus 1202 outputs audio in the first output mode, such that the volume perceived by the user as the user is using the electronic device in the second use state is the same as the volume perceived by the user as the user is using the electronic device in the second use state when the electronic device is in the second device state and the audio output apparatus 1202 outputs audio in the first output mode;

The volume parameter of the first output mode of the audio output apparatus 1202 when the electronic device is in the first device state is greater than the volume parameter of the first output mode of the audio output apparatus 1202 when the electronic device is in the second device state.

Taking a foldable phone as an example, the technical solution of the present disclosure is illustrated below.

In the present disclosure, the mode and state of the foldable phone during hands-free calls (such as closed, standing, tent, etc.) can be automatically detected, and multi-mode hands-free effect parameters such as volume, frequency response, channels, and timbre can be adaptively matched.

Specifically, in the early development stage, the hands-free effect parameters of the mobile phone in different device states and different use states can be designed through an intelligent model as described below.
A. In the early stage, the low, medium, and high frequencies of the dual speakers are finely tuned according to the phone's state (closed/standing/tent, etc.) to ensure balanced three frequencies and ensure that the audio quality heard by the user at a distance of 30-65 cm from the phone is excellent in various states. That is:
1) There is no noise and distortion, and the stereo effect will not have significant phase imbalance due to changes in the phone's form.
2) The volume will not be reduced or hindered due to changes in the phone's form, such as the sound of the upper speaker being muffled in the closed state.
B. By combining ultrasonic sensors and cameras, and utilizing an Artificial Intelligence (AI) Presence engine (i.e., an intelligent model), the user's distance from the phone is accurately determined, thereby the speaker volume is adaptively adjusted. This ensures that the volume is sufficiently loud and clear when the user is away from the phone (1 m), and the volume will not be excessively loud and the sound will remain relatively soft even when the user is close to the phone (10 cm).
C. Based on the phone's form (Hall sensor information), the different channel and frequency response parameters completed in A are imported, the delay in mode switching and parameter calling is reduced to within 10 ms, enabling instantaneous switching between modes, making the mode switching imperceptible to the user.
D. Utilizing AI mobile phone user voice data, and training the model based on a database of different callers'voice characteristics (e.g., female voices have more high-frequency components), the processor can predict whether the voice signal is from a female or a male bass voice, enabling adaptive frequency response processing. This ensures that the final signal output from the speaker achieves perfect matching, improving the user's listening.

It should be noted that the intelligent model here can also be a small local model deployed in the mobile phone.

Based on this, during the project implementation phase, after the mobile phone has been put into use, the audio output parameters already existing in the kernel are randomly called based on the device's state (information provided by sensors or ultrasound).

The various embodiments in this specification are described in a progressive manner, with each embodiment focusing on the differences from other embodiments. Similar parts among various embodiments can be cross-referenced. Relevant details about the devices disclosed in the embodiments can be found in the method description.

Those skilled in the art will further realize that the units and algorithmic steps of the various examples described in the present disclosure can be implemented by electronic hardware, computer software, or a combination of both. To clearly illustrate the interchangeability of hardware and software, the components and elements of the various embodiments have been generally described in terms of their functionality. Whether these functions are implemented in hardware or software depends on the specific application and design constraints of the technical solution. Those skilled in the art may use different methods to implement the described functions for each specific application, but such implementation should not be considered to be outside the scope of the present disclosure.

The elements described in the embodiments disclosed herein may be implemented directly in hardware, in software modules executed by a processor, or in a combination of both. The software modules may be stored in random access memory (RAM), memory, read-only memory (ROM), electrically programmable ROM, electrically erasable programmable ROM, registers, hard disk, removable disk, CD-ROM, or any other form of storage medium known in the art.

The above description of the disclosed embodiments enables those skilled in the art to implement or use the present disclosure. Various modifications to these embodiments will be readily apparent to those skilled in the art, and the general principles defined herein may be implemented in other embodiments without departing from the spirit or scope of the present disclosure. Therefore, the present disclosure will not be limited to the embodiments shown herein, but is to be accorded the broadest scope consistent with the principles and novel features disclosed herein.

What is claimed is:

1. A control method comprising:
obtaining first sensing information configured to indicate a device state of an electronic device; and
in response to the first sensing information indicating that the device state of the electronic device is a first device state, configuring an audio output apparatus to a first output mode, to enable the audio output apparatus to output audio in the first output mode in response to a call instruction;
wherein, when the electronic device is in the first device state, a target object of the electronic device blocks an audio output area of the audio output apparatus.

2. The method according to claim 1, further comprising:
in response to the first sensing information indicating that the device state of the electronic device is a second device state, configuring the audio output apparatus to a second output mode, to enable the audio output apparatus to output audio in the second output mode in response to the call instruction, the second output mode being different from the first output mode;
wherein, when the electronic device is in the second device state, the target object of the electronic device does not block the audio output area of the audio output apparatus.

3. The method according to claim 2, further comprising:
calling the audio output apparatus in response to a call connection being established.

4. The method according to claim 3, further comprising:
obtaining second sensing information configured to indicate a use state by a user of the electronic device.

5. The method according to claim 4, wherein:
a volume perceived by the user in a first use state of the electronic device when the electronic device is in the first device state and the audio output apparatus outputs audio in the first output mode is same as a volume perceived by the user in the first use state of the electronic device when the electronic device is in the second device state and the audio output apparatus outputs audio in the second output mode.

6. The method according to claim 4, further comprising:
in response to the second sensing information indicating a second use state, and the electronic device is in the second device state, controlling the audio output apparatus to switch from the second output mode to the first output mode;
wherein a volume perceived by the user in the second use state of the electronic device when the electronic device is in the first device state and the audio output apparatus outputs audio in the first output mode is same as a volume perceived by the user in the second use state of the electronic device when the electronic device is in the second device state and the audio output apparatus outputs audio in the first output mode.

7. The method according to claim 4, wherein:
a volume parameter of the first output mode of the audio output apparatus when the electronic device is in the first device state is greater than a volume parameter of the first output mode of the audio output apparatus when the electronic device is in the second device state.

8. The method according to claim 4, further comprising, before the audio output apparatus outputs audio:
adjusting, using an intelligent model, audio output parameters of audio output by the audio output apparatus based on the first sensing information and the second sensing information, the audio output parameters including at least one of volume, frequency response, or timbre;
wherein the intelligent model is obtained by training based on historical data of audio data usage by the user of the electronic device.

9. An electronic device comprising:
a sensing component, configured to obtain first sensing information configured to indicate a device state of the electronic device;
an audio output apparatus, configured to output audio, and having a first output mode and a second output mode different from the first output mode; and
a processor, configured to, in response to the first sensing information indicating that the device state of the electronic device is a first device state, configure the audio output apparatus to the first output mode, to enable the audio output apparatus to output audio in the first output mode in response to a call instruction;
wherein, when the electronic device is in the first device state, a target object of the electronic device blocks an audio output area of the audio output apparatus.

10. The electronic device according to claim 9, further comprising:
a first body; and
a second body;
wherein:
the audio output apparatus is located within the first body, and the audio output area of the audio output apparatus is located at a first surface of the first body;
when the first body and the second body are stacked, a first surface of the second body covers the audio output area; and
when the first body and the second body are unfolded, the first surface of the first body and the first surface of the second body are coplanar.

11. The electronic device according to claim 9, further comprising:
a body, the audio output apparatus being located within the body, and the audio output area of the audio output apparatus being located at a first surface of the body; and
a flexible screen, including a first part and a second part, the second part being a deformable part;
wherein the first part is configured to move relative to the body based on deformation of the second part, and a first surface of the first part is parallel to the first surface of the body.

12. The electronic device according to claim 11, wherein:
in response to the second part being deformed to a first form, the first part moves to a first position, and the first surface of the first part at the first position covers the audio output area; and
in response to the second part being deformed to a second form, the first part moves to a second position, and the first surface of the first part at the second position does not cover the audio output area.

13. The electronic device according to claim 9, further comprising:
a communication component, configured to establish a call connection between the electronic device and another device;
wherein the audio output apparatus is configured to be activated in response to the call connection being established.

14. The electronic device according to claim 9, wherein the processor is further configured to:
in response to the first sensing information indicating that the device state of the electronic device is a second device state, configure the audio output apparatus to a second output mode, to enable the audio output apparatus to output audio in the second output mode in response to the call instruction, the second output mode being different from the first output mode;
wherein, when the electronic device is in the second device state, the target object of the electronic device does not block the audio output area of the audio output apparatus.

15. The electronic device according to claim 14, wherein the processor is further configured to:
call the audio output apparatus in response to a call connection being established.

16. The electronic device according to claim 15, wherein the processor is further configured to:
obtain second sensing information configured to indicate a use state by a user of the electronic device.

17. The electronic device according to claim 16, wherein:
a volume perceived by the user in a first use state of the electronic device when the electronic device is in the first device state and the audio output apparatus outputs audio in the first output mode is same as a volume perceived by the user in the first use state of the electronic device when the electronic device is in the second device state and the audio output apparatus outputs audio in the second output mode.

18. The electronic device according to claim 16, wherein:
the processor is further configured to, in response to the second sensing information indicates a second use state, and the electronic device is in the second device state, control the audio output apparatus to switch from the second output mode to the first output mode; and
a volume perceived by the user in the second use state of the electronic device when the electronic device is in the first device state and the audio output apparatus outputs audio in the first output mode is same as a volume perceived by the user in the second use state of the electronic device when the electronic device is in the second device state and the audio output apparatus outputs audio in the first output mode.

19. The electronic device according to claim 16, wherein:
the volume parameter of the first output mode of the audio output apparatus when the electronic device is in the first device state is greater than the volume parameter of the first output mode of the audio output apparatus when the electronic device is in the second device state.

20. A non-transitory computer-readable storage medium storing instructions that, when executed by a processor, cause an electronic device including the processor to:
obtain first sensing information configured to indicate a device state of the electronic device; and
in response to the first sensing information indicating that the device state of the electronic device is a first device state, configure an audio output apparatus to a first output mode, to enable the audio output apparatus to output audio in the first output mode in response to a call instruction;
wherein, when the electronic device is in the first device state, a target object of the electronic device blocks an audio output area of the audio output apparatus.
